(19) United States
(12) Patent Application Publication
(10) Pub. No.: US 2019/0143972 A1
(43) Pub. Date: May 16, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Atsushi Ishioka, Wako-shi (JP); Masanori Takeda, Wako-shi (JP); Daichi Kato, Wako-shi (JP)

(21) Appl. No.: 16/118,476

(22) PCT Filed: Mar. 15, 2016
(86) PCT No.: PCT/JP2016/058187

§ 371 Date: Aug. 31, 2018

(51) Int. Cl. B60W 30/16; B60W 30/095; B60W 30/18; G06K 9/00; G08G 1/16

(52) U.S. Cl. CPC B60W 30/162; B60W 30/0956; B60W 30/18163; B60W 2550/304; G08G 1/167; B60W 2550/308; G06K 9/00798

(57) ABSTRACT

The invention provides a vehicle control system including a vehicle detector that detects a nearby vehicle with respect to an own-vehicle and an automated driving controller that automatically controls at least acceleration/deceleration of the own-vehicle such that the own-vehicle can travel along a route to a destination, wherein the automated driving controller acquires information indicating a position of a specific region in which the number of lanes decreases from map information and sets, if a relative relationship between the own-vehicle and a nearby vehicle detected by the vehicle detector satisfies a predetermined condition when the own-vehicle passes through the acquired specific region, a target speed of the own-vehicle to less than a speed of the nearby vehicle for which the relative relationship satisfies the predetermined condition.

### TECHNICAL FIELD

The present invention relates to a vehicle control system, a vehicle control method, and a vehicle control program.

### BACKGROUND ART

A technology for controlling the speed of an own-vehicle on the basis of the distance to a preceding vehicle traveling in front of the own-vehicle is known. In relation to this, a driving support device that includes an instruction means that instructs start of automated driving of the own-vehicle through an operation of the driver, a setting means that sets a destination of the automated driving, a determination means that determines a mode of the automated driving on the basis of whether or not the destination has been set when the instruction means is operated by the driver, and a control means that performs vehicle travel control on the basis of the mode of the automated driving determined by the determination means, wherein the determination means determines that the mode of the automated driving is automated driving for traveling along the current travel route of the own-vehicle or automated stopping when no destination has been set is known (see, for example, Patent Document 1).

### CITATION LIST

### Patent Literature

[Patent Document 1]

PCT International Publication No. WO2011/158347

### SUMMARY OF INVENTION

### Technical Problem

However, in the technology of the related art, a behavior of the own-vehicle is sometimes determined without sufficient consideration of the surrounding environment.

The present invention has been made in view of such circumstances and it is an object of the present invention to provide a vehicle control system, a vehicle control method, and a vehicle control program which can realize gentle vehicle control for nearby vehicles.

### Solution to Problem

The invention according to claim 1 is a vehicle control system (100) including a vehicle detector (130) configured to detect a nearby vehicle with respect to an own-vehicle, and an automated driving controller (120) configured to automatically control at least acceleration/deceleration of the own-vehicle such that the own-vehicle can travel along a route to a destination, wherein the automated driving controller is configured to acquire information indicating a position of a specific region in which the number of lanes decreases from map information and to set, if a relative relationship between the own-vehicle and a nearby vehicle detected by the vehicle detector satisfies a predetermined condition when the own-vehicle passes through the acquired specific region, a target speed of the own-vehicle to less than a speed of the nearby vehicle for which the relative relationship satisfies the predetermined condition.

The invention according to claim 2 is the vehicle control system according to claim 1, further including a predictor (159) configured to predict lane change of the nearby vehicle to an own-lane in which the own-vehicle travels, wherein the automated driving controller is configured to, if the relative relationship between the own-vehicle and a nearby vehicle detected by the vehicle detector satisfies the predetermined condition and the predictor has predicted that the nearby vehicle will change lanes to the own-lane, set the speed of the own vehicle to a speed less than the speed of the nearby vehicle.

The invention according to claim 3 is the vehicle control system according to claim 1 or 2, wherein the predetermined condition includes a condition that a position of the nearby vehicle be within a predetermined region lateral to the own-vehicle, a front part of the predetermined region with respect to the own-vehicle being wider than a rear part of the predetermined region with respect to the own-vehicle.

The invention according to claim 4 is the vehicle control system according to claim 3, wherein the predetermined region is set in a lane that is closed as the number of lanes decreases.

The invention according to claim 5 is a vehicle control system (100) including a vehicle detector (130) configured to detect a nearby vehicle with respect to an own-vehicle, a predictor (159) configured to predict lane change of the nearby vehicle to an own-lane in which the own-vehicle travels, and an automated driving controller (120) configured to automatically control at least acceleration/deceleration of the own-vehicle such that the own-vehicle can travel along a route to a destination, wherein the automated driving controller is configured to acquire information indicating a position of a specific region in which the number of lanes increases or a lane branches from map information and to set, if a relative relationship between the own-vehicle and a nearby vehicle detected by the vehicle detector satisfies a predetermined condition and the predictor has predicted that the nearby vehicle will change lanes to the own-lane when the own-vehicle passes through the acquired specific region, a speed of the own-vehicle to less than the speed of the nearby vehicle.

The invention according to claim 6 is the vehicle control system according to claim 5, wherein the predetermined condition includes a condition that a position of the nearby vehicle be within a predetermined region lateral to the own-vehicle, a front part of the predetermined region with respect to the own-vehicle being wider than a rear part of the predetermined region with respect to the own-vehicle.

The invention according to claim 7 is a vehicle control system (100) including a vehicle detector (130) configured to detect a nearby vehicle with respect to an own-vehicle, a predictor (159) configured to predict lane change of the nearby vehicle to an own-lane in which the own-vehicle travels, and an automated driving controller (120) configured to automatically control at least acceleration/deceleration of the own-vehicle such that the own-vehicle can travel along a route to a destination, wherein the automated driving controller is configured to acquire information indicating a position of a first specific region in which the number of lanes decreases and a position of a second specific region in which the number of lanes increases or a lane branches from map information, set a speed of the own-vehicle to less than a speed of a nearby vehicle detected by the vehicle detector if a relative relationship between the own-vehicle and the nearby vehicle detected by the vehicle detector satisfies a predetermined condition when the own-vehicle passes through the first specific region, and set the speed of the own-vehicle to less than a speed of a nearby vehicle detected by the vehicle detector if a relative relationship between the own-vehicle and the nearby vehicle detected by the vehicle detector satisfies a predetermined condition and the predictor has predicted that the nearby vehicle will change lanes to the own-lane when the own-vehicle passes through the second specific region.

The invention according to claim 8 is the vehicle control system according to any one of claims 1 to 7, wherein the predetermined condition includes a condition that a relative speed between the nearby vehicle and the own-vehicle be within a predetermined speed range.

The invention according to claim 9 is the vehicle control system according to any one of claims 1 to 8, wherein the automated driving controller is configured to perform control for setting the speed of the own-vehicle to a speed less than the speed of the nearby vehicle when the speed of the own-vehicle is equal to or higher than a predetermined speed.

The invention according to claim 10 is a vehicle control system including a vehicle detector configured to detect a nearby vehicle with respect to an own-vehicle, and an automated driving controller configured to automatically control at least acceleration/deceleration of the own-vehicle such that the own-vehicle can travel along a route to a destination, wherein the automated driving controller is configured to acquire information indicating a position of a specific region in which the number of lanes decreases from map information and to adjust a speed of the own-vehicle such that an inter-vehicle distance between the own-vehicle and a preceding vehicle that travels immediately in front of the own-vehicle among nearby vehicles detected by the vehicle detector is equal to or greater than a predetermined distance if a relative relationship between the own-vehicle and a side-traveling vehicle that travels in a lane adjacent to a lane in which the own-vehicle travels among the nearby vehicles detected by the vehicle detector satisfies a predetermined condition when the own-vehicle passes through the acquired specific region.

The invention according to claim 11 is a vehicle control method wherein an in-vehicle computer configured to automatically control at least acceleration/deceleration of an own-vehicle such that the own-vehicle can travel along a route to a destination acquires information indicating a position of a specific region in which the number of lanes decreases from map information and sets, if a relative relationship between the own-vehicle and a nearby vehicle detected by a vehicle detector configured to detect nearby vehicles of the own-vehicle satisfies a predetermined condition when the own-vehicle passes through the acquired specific region, a target speed of the own-vehicle to less than a speed of the nearby vehicle for which the relative relationship satisfies the predetermined condition.

The invention according to claim 12 is a vehicle control program causing an in-vehicle computer configured to automatically control at least acceleration/deceleration of the own-vehicle such that the own-vehicle can travel along a route to a destination to acquire information indicating a position of a specific region in which the number of lanes decreases from map information and to set, if a relative relationship between the own-vehicle and a nearby vehicle detected by a vehicle detector configured to detect nearby vehicles of the own-vehicle satisfies a predetermined condition when the own-vehicle passes through the acquired specific region, a target speed of the own-vehicle to less than a speed of the nearby vehicle for which the relative relationship satisfies the predetermined condition.

### Advantageous Effects of Invention

According to the first, third, fourth, eleventh, and twelfth aspects of the present invention, if the relative relationship between the own-vehicle and the nearby vehicle satisfies a predetermined condition when the own-vehicle passes through a specific region in which the number of lanes decreases, the target speed of the own-vehicle is set to less than the speed of the nearby vehicle for which the relative relationship satisfies the predetermined condition. Thereby, it is possible to realize gentle vehicle control for the nearby vehicle.

According to the second aspect of the present invention, if the relative relationship between the own-vehicle and the nearby vehicle satisfies the predetermined condition and the predictor has predicted that the nearby vehicle will change lanes to the own-lane when the own-vehicle passes through a specific region in which the number of lanes decreases, the speed of the own vehicle is reduced to less than the speed of the nearby vehicle. Thereby, it is possible to realize gentle vehicle control for the nearby vehicle with higher precision.

According to the fifth or sixth aspect of the present invention, if the relative relationship between the nearby vehicle and the own-vehicle satisfies a predetermined condition when the own-vehicle passes through a specific region in which the number of lanes increases or a lane branches, the speed of the own-vehicle is reduced to less than the speed of the nearby vehicle and, if the relative relationship between the own-vehicle and the nearby vehicle satisfies a predetermined condition and the predictor has predicted that the nearby vehicle will change lanes to the own-lane when the own-vehicle passes through a specific region in which the number of lanes increases or a lane separates, the speed of the own-vehicle is reduced to less than the speed of the nearby vehicle. Thereby, it is possible to realize gentle vehicle control for the nearby vehicle.

According to the seventh aspect of the present invention, if the relative relationship between the own-vehicle and the nearby vehicle satisfies a predetermined condition when the own-vehicle passes through the first specific region in which the number of lanes decreases, the speed of the own-vehicle is reduced to less than the speed of the nearby vehicle and also, if the relative relationship between the own-vehicle and the nearby vehicle satisfies a predetermined condition and the nearby vehicle has been predicted to change lanes to the own-lane when the own-vehicle passes through the second specific region in which the number of lanes increases or a lane branches, the speed of the own-vehicle is reduced to less than the speed of the nearby vehicle. Thereby, it is possible to realize gentle vehicle control for the nearby vehicle.

According to the eighth aspect of the present invention, the predetermined condition includes a condition that the relative speed between the nearby vehicle and the own-vehicle be within a predetermined speed range. Accordingly, the speed of the own-vehicle is not reduced when the speed of the own-vehicle is higher or lower than the speed of the nearby vehicle by a predetermined speed or more. Therefore, it is possible to appropriately control the own-vehicle according to the traveling state of the own-vehicle or the nearby vehicle.

According to the ninth aspect of the present invention, the automated driving controller performs control for setting the speed of the own-vehicle to a speed less than the speed of the nearby vehicle when the speed of the own-vehicle is equal to or higher than a predetermined speed. Therefore, in road conditions where the speed of the vehicle is less than a predetermined value due to traffic congestion or the like, the vehicle is caused to travel while keeping the current speed without reducing the speed of the own-vehicle. As a result, it is possible to appropriately control the speed of the own-vehicle according to the road conditions.

According to the tenth aspect of the present invention, the automated driving controller adjusts the speed of the own-vehicle such that the inter-vehicle distance between the own-vehicle and a preceding vehicle that travels immediately in front of the own-vehicle among the nearby vehicles is equal to or greater than a predetermined distance. Thereby, it is possible to prompt a nearby vehicle to change lanes even when there is a preceding vehicle.

### BRIEF DESCRIPTION OF DRAWINGS

FIG. 1 is a diagram showing constituent elements of a vehicle in which a vehicle control system 100 of each embodiment is mounted.

FIG. 2 is a functional configuration diagram of an own-vehicle M in which a vehicle control system 100 according to a first embodiment is mounted.

FIG. 3 is a diagram showing how the relative position of the own-vehicle M with respect to a traveling lane L1 is recognized by an own-vehicle position recognizer 122.

FIG. 4 is a diagram showing an example of a behavior plan generated for a certain section.

FIG. 5 is a diagram showing an example of the configuration of a trajectory generator 150.

FIG. 6 is a diagram showing examples of candidate trajectories generated by a candidate trajectory generator 154.

FIG. 7 is a flowchart showing an example of a flow of processing performed when a lane change event is performed.

FIG. 8 is a diagram showing how a target position TA is set.

FIG. 9 is a diagram showing how a trajectory for lane change is generated.

FIG. 10 is a diagram showing an example of a specific region table 183.

FIG. 11 is a diagram showing an example of a road shape at a location where a lane branches or the number of lanes increases.

FIG. 12 is a diagram showing a part of a flowchart showing the flow of processing that an automated driving controller 120 performs when passing through a specific region FR.

FIG. 13 is a diagram showing a positional relationship between the own-vehicle M and a nearby vehicle m.

FIG. 14 is a diagram showing a flow of processing of a modified example of the flowchart of FIG. 12.

FIG. 15 is a diagram showing another part of the flowchart showing the flow of processing that the automated driving controller 120 performs when passing through a specific region FR.

FIG. 16 is a diagram showing an example of a situation in which a nearby vehicle m has been predicted to change lanes.

FIG. 17 is a functional configuration diagram of an own-vehicle M centering on a vehicle control system 100A according to a second embodiment.

FIG. 18 is a diagram showing an example of a situation in which a following controller 126 performs setting for the own-vehicle M on the basis of the speed of a target vehicle.

### DESCRIPTION OF EMBODIMENTS

Hereinafter, embodiments of a vehicle control system, a vehicle control method, and a vehicle control program according to the present invention will be described with reference to the drawings.

### <Common Configuration>

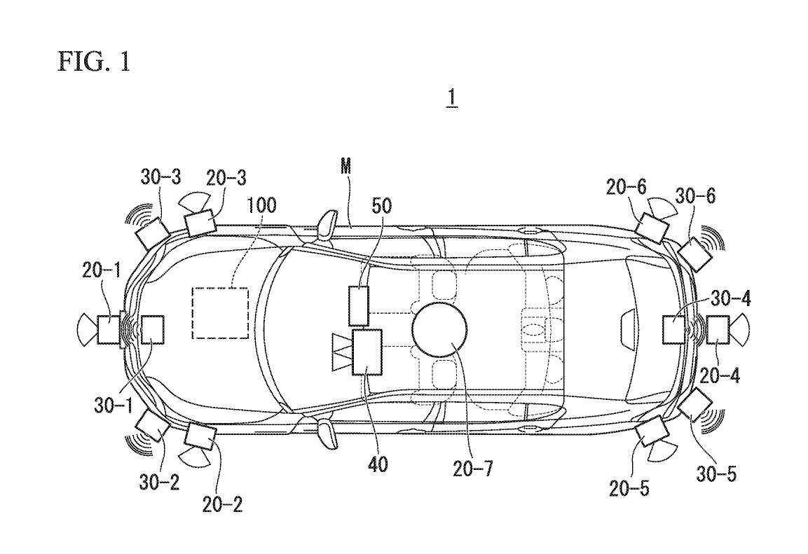

FIG. 1 is a diagram showing constituent elements of a vehicle (hereinafter referred to as an own-vehicle M) in which a vehicle control system 100 of each embodiment is mounted. The vehicle in which the vehicle control system 100 is mounted is, for example, an automobile such as a two-wheeled vehicle, a three-wheeled vehicle, or a four-wheeled vehicle and also includes an automobile that uses an internal combustion engine such as a diesel engine or a gasoline engine as a power source or an electric vehicle that uses an electric motor as a power source, a hybrid vehicle having both an internal combustion engine and an electric motor, or the like. Electric vehicles are driven, for example, using electric power discharged from batteries such as secondary batteries, hydrogen fuel cells, metal fuel cells, or alcohol fuel cells.

As shown in FIG. 1, sensors such as finders 20-1 to 20-7, radars 30-1 to 30-6, and a camera 40, a navigation device 50, and the vehicle control system 100 are mounted to the own-vehicle M.

The finders 20-1 to 20-7 are, for example, light detection and ranging or laser imaging detection and ranging (LIDAR) finders which measure scattered light from an object in response to illuminated light to measure the distance to the object. For example, the finder 20-1 is attached to a front grille or the like and the finders 20-2 and 20-3 are attached to a side surface of a vehicle body, a door mirror, an inside portion of a headlight, a portion in the vicinity of a side lamp, or the like. The finder 20-4 is attached to a trunk lid or the like and the finders 20-5 and 20-6 are attached to a side surface of the vehicle body, an inside portion of a taillight, or the like. The finders 20-1 to 20-6 described above have detection areas of, for example, about 150 degrees in the horizontal direction. Further, the finder 20-7 is attached to a roof or the like. The finder 20-7 has a detection area of, for example, 360 degrees in the horizontal direction.

The radars 30-1 and 30-4 are, for example, long range millimeter-wave radars which have wider detection areas in the longitudinal direction than the other radars. The radars 30-2, 30-3, 30-5, and 30-6 are intermediate range millimeter-wave radars which have narrower detection areas in the longitudinal direction than the radars 30-1 and 30-4.

Hereinafter, the finders 20-1 to 20-7 are each simply referred to as a “finder 20” when they are not particularly distinguished and the radars 30-1 to 30-6 are each simply referred to as a “radar 30” when they are not particularly distinguished. The radar 30 detects a body, for example, through a frequency modulated continuous wave (FM-CW) method.

The camera 40 is, for example, a digital camera using a solid-state imaging device such as a charge coupled device (CCD) or complementary metal oxide semiconductor (CMOS) imaging device. The camera 40 is attached to an upper portion of a front windshield, a rear surface of a rearview mirror, or the like. For example, the camera 40 periodically images the area in front of the own-vehicle M repeatedly. The camera 40 may be a stereo camera including a plurality of cameras.

It is to be noted that the components shown in FIG. 1 are merely an example and some of the components may be omitted or other components may be added.

### First Embodiment

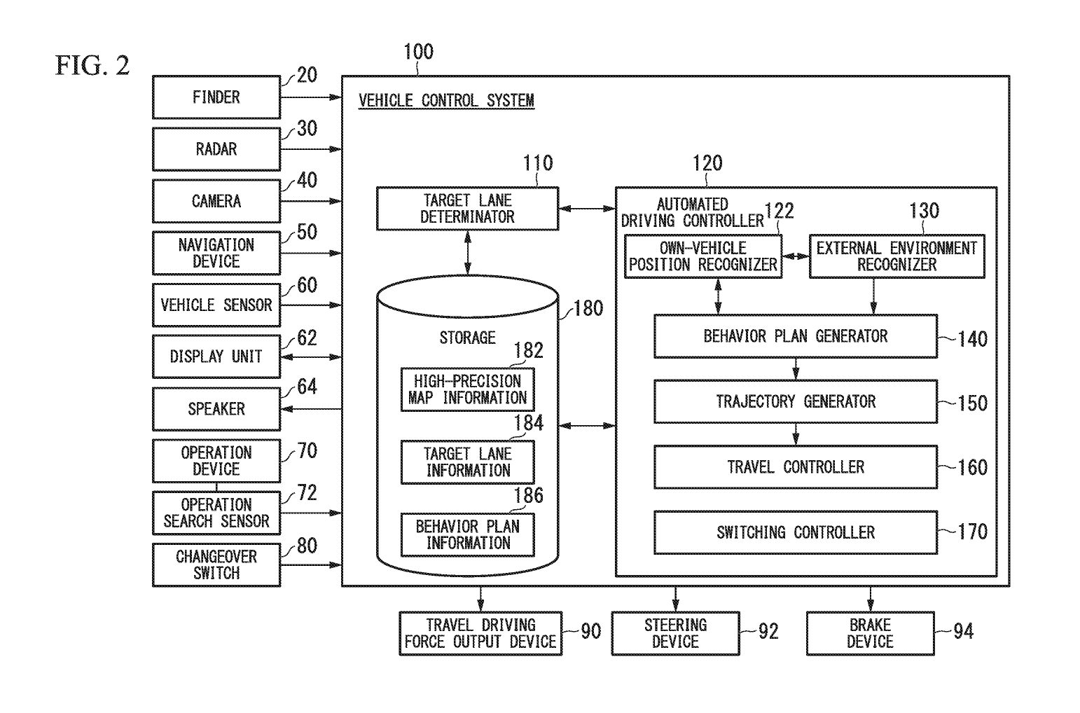

FIG. 2 is a functional configuration diagram of the own-vehicle M in which the vehicle control system 100 according to the first embodiment is mounted. In addition to the finders 20, the radars 30, and the cameras 40, the navigation device 50, vehicle sensors 60, a display unit 62, a speaker 64, operation devices (operators) 70 such as an accelerator pedal, a brake pedal, a shift lever (or a paddle shifter), and a steering wheel, operation detection sensors 72 such as an accelerator opening sensor, a brake pedal depression amount sensor (a brake switch), a shift position sensor, and a steering angle sensor (or a steering torque sensor), a changeover switch 80, a travel driving force output device 90, a steering device 92, a brake device 94, and the vehicle control system 100 are mounted on the own-vehicle M. These devices and apparatuses are connected to each other through a multiplex communication line such as a controller area network (CAN) communication line, a serial communication line, a wireless communication network, or the like. The shown operation devices are merely an example and a joystick, a button, a dial switch, a graphical user interface (GUI) switch, and the like may be mounted in the own-vehicle M. It is to be noted that the vehicle control system in the claims may include not only the vehicle control system 100 alone but also include components (such as the finders 20) other than the vehicle control system 100 among the components shown in FIG. 2.

The navigation device 50 has a global navigation satellite system (GNSS) receiver, map information (a navigation map), a touch panel type display device functioning as a user interface, a speaker, a microphone, or the like. The navigation device 50 identifies the position of the own-vehicle M through the GNSS receiver and derives a route from the position to a destination specified by the user. The route derived by the navigation device 50 is provided to a target lane determinator 110 of the vehicle control system 100. The position of the own-vehicle M may also be identified or supplemented by an inertial navigation system (INS) using outputs of the vehicle sensors 60. When the vehicle control system 100 is performing a manual driving mode, the navigation device 50 performs guidance regarding a route to the destination through voice or navigation display. Here, the component(s) for identifying the position of the own-vehicle M may be provided independently of the navigation device 50. The navigation device 50 may also be realized, for example, by a function of a terminal device such as a smartphone or a tablet terminal possessed by the user. In this case, information is transmitted and received between the terminal device and the vehicle control system 100 through wireless or wired communication.

The vehicle sensors 60 include, for example, a vehicle speed sensor that detects the speed of the vehicle, an acceleration sensor that detects the acceleration thereof, a yaw rate sensor that detects an angular speed thereof about the vertical axis, an orientation sensor that detects the orientation of the own-vehicle M, or the like.

The display unit 62 displays information as an image. The display unit 62 includes, for example, a liquid crystal display (LCD), an organic electroluminescence (EL) display device, a head-up display, or the like. The display unit 62 may also be a display unit included in the navigation device 50 or a display unit of an instrument panel that displays the state (such as the speed) of the own-vehicle M. The speaker 64 outputs information as sound.

The operation detection sensors 72 output an accelerator opening degree, a brake pedal depression amount, a shift position, a steering angle, a steering torque, and the like as detection results to the vehicle control system 100. Alternatively, the detection results of the operation detection sensors 72 may be output directly to the travel driving force output device 90, the steering device 92, or the brake device 94 depending on the driving mode.

The changeover switch 80 is a switch that is operated by an occupant. The changeover switch 80 receives an operation of the occupant, generates a driving mode designation signal designating the driving mode of the own-vehicle M, and outputs the driving mode designation signal to the switching controller 170. The changeover switch 80 may be any of a graphical user interface (GUI) switch or a mechanical switch.

The travel driving force output device 90 outputs a travel driving force (torque) required for the vehicle to travel to driving wheels. For example, when the own-vehicle M is a vehicle that uses an internal combustion engine as a power source, the travel driving force output device 90 includes the engine, a transmission, and an engine electronic control unit (ECU) that controls the engine. When the own-vehicle M is an electric vehicle that uses an electric motor as a power source, the travel driving force output device 90 includes a traveling motor and a motor ECU that controls the traveling motor. When the own-vehicle M is a hybrid car, the travel driving force output device 90 includes an engine, a transmission, an engine ECU, a traveling motor, and a motor ECU. When the travel driving force output device 90 includes only the engine, the engine ECU adjusts the throttle opening degree of the engine, the shift stage, or the like according to information input from a travel controller 160 which will be described later. When the travel driving force output device 90 includes only the traveling motor, the motor ECU adjusts the duty ratio of a PWM signal to be provided to the traveling motor according to information input from the travel controller 160. When the travel driving force output device 90 includes the engine and the traveling motor, the engine ECU and the motor ECU cooperate with each other to control the travel driving force according to information input from the travel controller 160.

The steering device 92 includes, for example, a steering ECU and an electric motor. The electric motor, for example, applies a force to a rack-and-pinion mechanism to change the direction of steering wheels. The steering ECU drives the electric motor according to information input from the vehicle control system 100 or according to input steering angle or steering torque information to change the direction of the steering wheels.

The brake device 94 is, for example, an electric servo brake device including a brake caliper, a cylinder that transmits hydraulic pressure to the brake caliper, an electric motor that generates hydraulic pressure in the cylinder, and a brake controller. The brake controller of the electric servo brake device controls the electric motor according to information input from the travel controller 160 such that a brake torque corresponding to a braking operation is output to each wheel. The electric servo brake device may include, as a backup, a mechanism for transmitting a hydraulic pressure generated by an operation of the brake pedal to the cylinder via a master cylinder. It is to be noted that the brake device 94 is not limited to the electric servo brake device described above and may be an electronically controlled hydraulic brake device. The electronically controlled hydraulic brake device controls an actuator according to information input from the travel controller 160 and transmits the hydraulic pressure of the master cylinder to the cylinder. The brake device 94 may also include a regenerative brake using a traveling motor that may be included in the travel driving force output device 90.

### [Vehicle Control System]

The vehicle control system 100 will now be described. The vehicle control system 100 is realized, for example, by one or more processors or hardware having equivalent functions. The vehicle control system 100 may also be configured of a combination of an electronic control unit (ECU), a micro-processing unit (MPU), or the like in which a processor such as a central processing unit (CPU), a storage device, a communication interface are connected to each other via an internal bus.

The vehicle control system 100 includes, for example, a target lane determinator 110, an automated driving controller 120, and a storage 180. The automated driving controller 120 includes, for example, an own-vehicle position recognizer 122, an external environment recognizer 130, a behavior plan generator 140, a trajectory generator 150, a travel controller 160, and a switching controller 170. Each of the target lane determinator 110 and the automated driving controller 120 is partly or wholly realized by a processor executing a program (software). Some or all of these components may be realized by hardware such as a large scale integration (LSI) or an application specific integrated circuit (ASIC) or may be realized by a combination of software and hardware.

The storage 180 stores, for example, information such as high-precision map information 182, target lane information 184, and behavior plan information 186. The storage 180 is realized by a read only memory (ROM), a random access memory (RAM), a hard disk drive (HDD), a flash memory, or the like. The program that is executed by the processor may be stored in the storage 180 in advance or may be downloaded from an external device via an in-vehicle Internet facility or the like. The program may be installed in the storage 180 by mounting a portable storage medium storing the program in a drive device (not shown). The vehicle control system 100 may be distributed over a plurality of computer devices.

The target lane determinator 110 is realized, for example, by an MPU. The target lane determinator 110 divides a route provided from the navigation device 50 into a plurality of blocks (for example, into blocks each 100 meters long in the direction in which the vehicle travels) and determines a target lane for each block by referring to the high-precision map information 182. The target lane determinator 110 determines the target lane, for example, such that it is given a position in a lane order counted from the leftmost lane. For example, when there is a branch location, a merge location, or the like on the route, the target lane determinator 110 determines a target lane such that the own-vehicle M can run on a reasonable travel route for proceeding to a branch destination. The target lane determined by the target lane determinator 110 is stored in the storage 180 as target lane information 184.

The high-precision map information 182 is map information with higher precision than the navigation map included in the navigation device 50. Information indicating the positions of specific regions in which vehicles frequently change lanes is stored in the high-precision map information 182. The details of the specific regions will be described later.

Further, the high-precision map information 182 includes, for example, information of the centers of lanes or information of the boundaries of lanes. The high-precision map information 182 may also include road information, traffic regulations information, address information (addresses/postal codes), facility information, telephone number information, or the like. The road information includes information indicating the types of roads such as expressways, toll roads, national roads, or prefectural roads or information such as the number of lanes of each road, the widths of lanes, the gradients of roads, the curvatures of curves of lanes, the positions of merge or branch points of lanes, signs installed on roads, or the like. The traffic regulations information includes information regarding closure of lanes due to construction, traffic accidents, traffic congestion, or the like.

The own-vehicle position recognizer 122 of the automated driving controller 120 recognizes a (traveling) lane in which the own-vehicle M is traveling and the relative position of the own-vehicle M with respect to the traveling lane on the basis of the high-precision map information 182 stored in the storage 180 and information input from the finders 20, the radars 30, the camera 40, the navigation device 50, or the vehicle sensors 60.

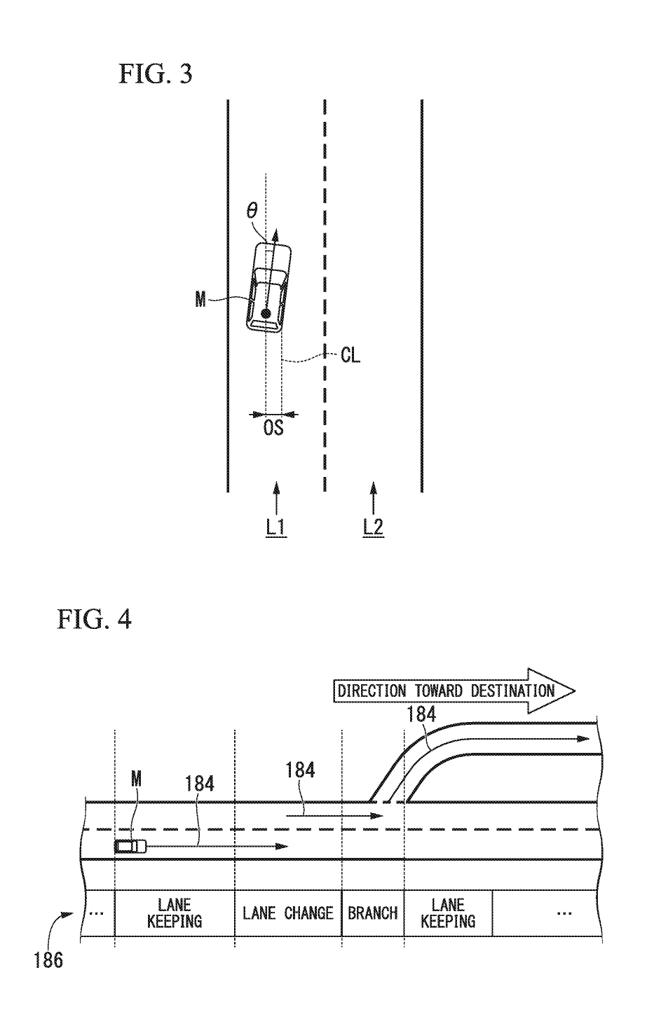

FIG. 3 is a diagram showing how the relative position of the own-vehicle M with respect to the traveling lane L1 is recognized by the own-vehicle position recognizer 122. For example, the own-vehicle position recognizer 122 recognizes both a deviation OS from a traveling lane center CL of a reference point (for example, the center of gravity) of the own-vehicle M and an angle θ formed by the travel direction of the own-vehicle M relative to an extension line of the traveling lane center CL as the relative position of the own-vehicle M with respect to the traveling lane L1. Alternatively, the own-vehicle position recognizer 122 may recognize the position of the reference point of the own-vehicle M with respect to one of the sides of the own-lane L1 or the like as the relative position of the own-vehicle M with respect to the traveling lane. The relative position of the own-vehicle M recognized by the own-vehicle position recognizer 122 is provided to the target lane determinator 110.

The external environment recognizer 130 recognizes states of a nearby vehicle(s) such as the position, speed, and acceleration thereof on the basis of information input from the finders 20, the radars 30, the camera 40 or the like. The nearby vehicle is, for example, a vehicle traveling in the same direction as the own-vehicle M near the own-vehicle M. The nearby vehicle may also be defined as a vehicle traveling in the same direction as the own-vehicle M in a lane adjacent to the traveling lane of the own-vehicle M. The position of the nearby vehicle may be represented by a representative point such as a center of gravity or a corner of the other vehicle or may be represented by a region expressed by a contour of the other vehicle. The “states” of the nearby vehicle may include an acceleration of the nearby vehicle and whether or not the nearby vehicle is changing lanes (or is about to change lanes) which are determined by information of various devices. The external environment recognizer 130 may also recognize the positions of guardrails or utility poles, parked vehicles, pedestrians, and other bodies in addition to nearby vehicles.

The behavior plan generator 140 sets a start point of automated driving and/or a destination of automated driving. The start point of automated driving may be the current position of the own-vehicle M or may be a position at which an operation for instructing the automated driving is performed. The behavior plan generator 140 generates a behavior plan for a section between the start point and the destination of the automated driving. It is to be noted that the present invention is not limited to this and the behavior plan generator 140 may generate a behavior plan for an arbitrary section.

The behavior plan includes, for example, a plurality of events to be performed sequentially. Examples of the events include a deceleration event for decelerating the own-vehicle M, an acceleration event for accelerating the own-vehicle M, a lane keeping event for causing the own-vehicle M to travel without deviating from the traveling lane, a lane change event for changing the traveling lane, an overtaking event for causing the own-vehicle M to overtake a preceding vehicle, a branching event for causing the own-vehicle M to change lanes to a desired lane or to travel without deviating from the current traveling lane at a branch point, and a merging event for causing the own-vehicle M in a merging lane for merging into a main line to accelerate or decelerate to change the traveling lane. The behavior plan generator 140 sets a lane change event, a branching event, or a merging event at a location at which the target lane determined by the target lane determinator 110 is switched. Information indicating the behavior plan generated by the behavior plan generator 140 is stored in the storage 180 as the behavior plan information 186.

FIG. 4 is a diagram showing an example of a behavior plan generated for a certain section. As shown, the behavior plan generator 140 generates a behavior plan necessary for the own-vehicle M to travel in the target lane indicated by the target lane information 184. It is to be noted that the behavior plan generator 140 may dynamically change the behavior plan regardless of the target lane information 184 in accordance with a situation change of the own-vehicle M. For example, when the speed of a nearby vehicle recognized by the external environment recognizer 130 during travel of the own-vehicle M exceeds a threshold value or when the moving direction of a nearby vehicle which is traveling in a lane adjacent to the own-lane is toward the own-lane, the behavior plan generator 140 changes events set for a driving section which the own-vehicle M is scheduled to travel. For example, when events have been set such that a lane change event is performed after a lane keeping event, the behavior plan generator 140 may change the event next to the lane keeping event from the lane change event to a deceleration event, a lane keeping event, or the like if it is determined from a result of the recognition of the external environment recognizer 130 that a vehicle is running behind in the lane to which lane change is to be made at a speed equal to or higher than the threshold value during the lane keeping event. As a result, the vehicle control system 100 can cause the own-vehicle M to automatically travel safely even when a change has been made in the state of the external environment.

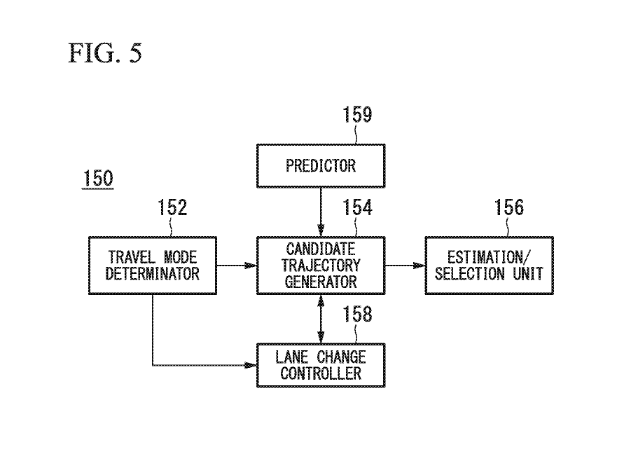

FIG. 5 is a diagram showing an example of the configuration of the trajectory generator 150. The trajectory generator 150 includes, for example, a travel mode determinator 152, a candidate trajectory generator 154, an evaluation/selection unit 156, a lane change controller 158, and a predictor 159.

When performing the lane keeping event, the travel mode determinator 152 determines one of the travel modes such as constant-speed travel, following travel, deceleration travel, curve travel, and obstacle avoidance travel. For example, the travel mode determinator 152 determines that the travel mode is constant-speed travel when there is no other vehicle in front of the own-vehicle M. In addition, the travel mode determinator 152 determines that the travel mode is following travel when causing the own-vehicle to travel following a preceding vehicle. Further, the travel mode determinator 152 determines that the travel mode is deceleration travel when deceleration of the preceding vehicle is recognized by the external environment recognizer 130 or when performing an event such as stopping or parking. Furthermore, the travel mode determinator 152 determines that the travel mode is curve travel when it is recognized by the external environment recognizer 130 that the own-vehicle M has reached a curved road. In addition, the travel mode determinator 152 determines that the travel mode is obstacle avoidance travel when an obstacle is recognized in front of the own-vehicle M by the external environment recognizer 130.

The candidate trajectory generator 154 generates a candidate trajectory on the basis of the travel mode determined by the travel mode determinator 152. A trajectory in the present embodiment is a collection of target positions (trajectory points) that the reference position (for example, the center of gravity and the center of a rear wheel shaft) of the own-vehicle M is to reach at each predetermined future time (or at each predetermined travel distance). The candidate trajectory generator 154 calculates a target speed of the own-vehicle M on the basis of at least the speed of an object OB present in front of the own-vehicle M recognized by the external environment recognizer 130 and the distance between the own-vehicle M and the object OB. The candidate trajectory generator 154 generates one or more trajectories on the basis of the calculated target speed. The object OB includes a preceding vehicle, a point such as a merge point, a branch point, or a target point, a body such as an obstacle, or the like.

In addition, if the relative relationship (for example, the relationship regarding the relative speed and the positional relationship) between a nearby vehicle and the own-vehicle M satisfies a predetermined condition when the own-vehicle M passes through a specific region, the candidate trajectory generator 154 calculates a target speed such that the speed of the own-vehicle M is reduced to less than the speed of the nearby vehicle that has satisfied the condition (hereinafter referred to as a target vehicle) and generates a trajectory corresponding to the calculated target speed. The details of this will be described later.

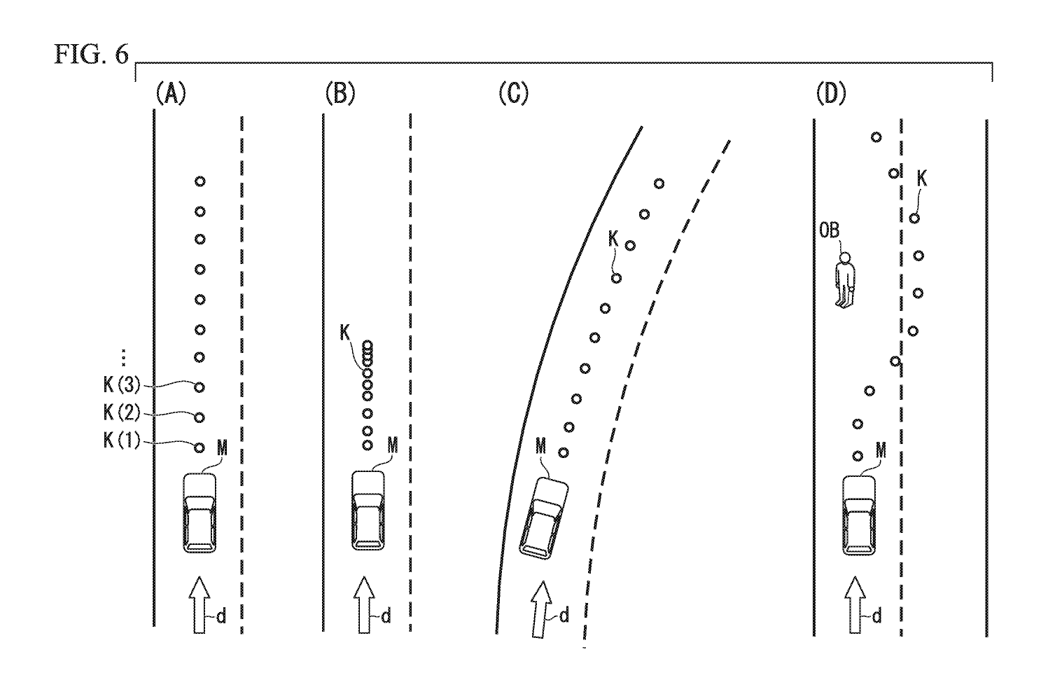

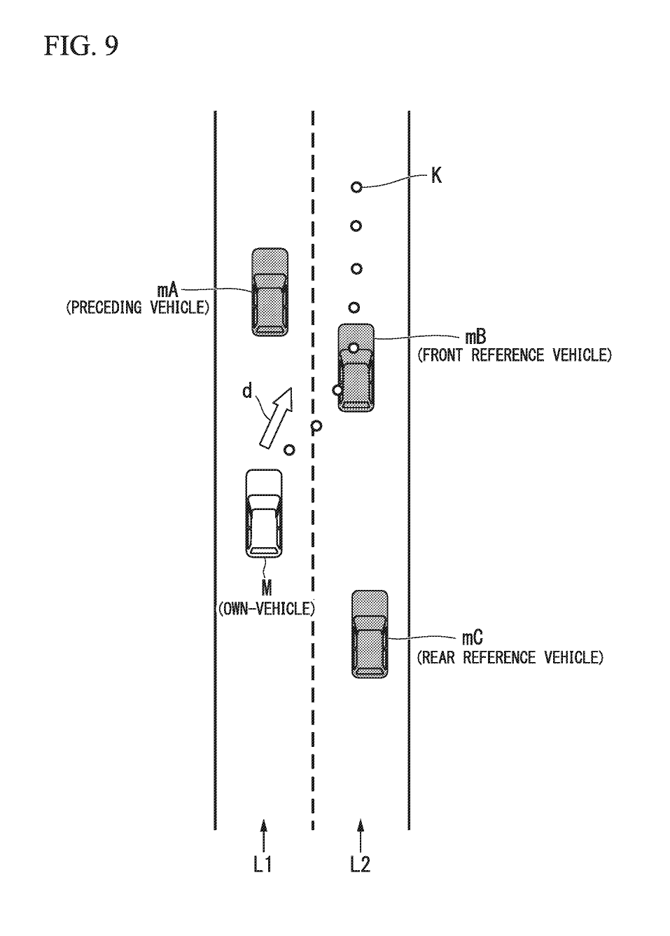

FIG. 6 is a diagram showing examples of candidate trajectories generated by the candidate trajectory generator 154. Of a plurality of candidate trajectories that can be set, only representative trajectories or trajectories selected by the evaluation/selection unit 156 are shown in and described with reference to FIG. 6 and FIG. 9 which will be described later. As shown in FIG. 6(A), for example, the candidate trajectory generator 154 calculates trajectory points such as K(1), K(2), K(3), . . . at predetermined time intervals Δt from the current time with reference to the current position of the own-vehicle M. Hereinafter, these trajectory points are sometimes simply referred to as “trajectory points K” when they are not distinguished.

When the travel mode determinator 152 determines that the travel mode is constant-speed travel, the candidate trajectory generator 154 sets a plurality of trajectory points K at equal intervals as shown in FIG. 6(A). When generating such simple trajectories, the candidate trajectory generator 154 may generate only one trajectory.

When the travel mode determinator 152 determines that the travel mode is deceleration travel (including the case in which a preceding vehicle decelerates during following travel), the candidate trajectory generator 154 generates a trajectory such that trajectory points K arrived at at earlier times are arranged at greater intervals and trajectory points K arrived at at later times are arranged at smaller intervals as shown in FIG. 6(B). In this case, the preceding vehicle may be set as an object OB or alternatively a point such as a merge point, a branch point, or a target point, an obstacle, or the like other than the preceding vehicle may be set as an object OB. Thus, the travel controller 160 which will be described later causes the own-vehicle M to decelerate since trajectory points K at later arrival times for the own-vehicle M are approaching the current position of the own-vehicle M.

When the travel mode determinator 152 determines that the travel mode is curve travel, as shown in FIG. 6(C), the candidate trajectory generator 154 arranges a plurality of trajectory points K according to the curvature of the road while changing the lateral position of the own-vehicle M with respect to the travel direction (the position thereof in the lateral direction of the lane). Further, when an obstacle OB such as a human being or a stopped vehicle is present on the road ahead of the own-vehicle M as shown in FIG. 6(D), the candidate trajectory generator 154 arranges a plurality of trajectory points K such that the own-vehicle travels while avoiding the obstacle OB.

The evaluation/selection unit 156 evaluates the candidate trajectories generated by the candidate trajectory generator 154 from two viewpoints, for example, a plan-related property and safety, and selects a trajectory to be output to the travel controller 160. From the viewpoint of the plan-related property, for example, a trajectory having higher conformity to a plan (for example, a behavior plan) that has already been generated and having a short total length is highly evaluated. For example, when it is desired that the own-vehicle change lanes to the right, a trajectory for changing lanes to the left and then returning is lowly evaluated. From the viewpoint of safety, for example, a trajectory in which the distance between the own-vehicle M and a body (such as a nearby vehicle) is long and the amount of change of the steering angle or acceleration/deceleration or the like is smaller is highly evaluated.

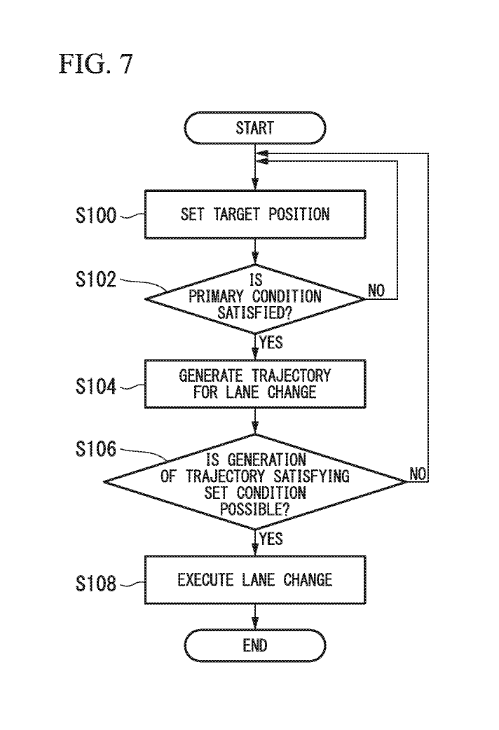

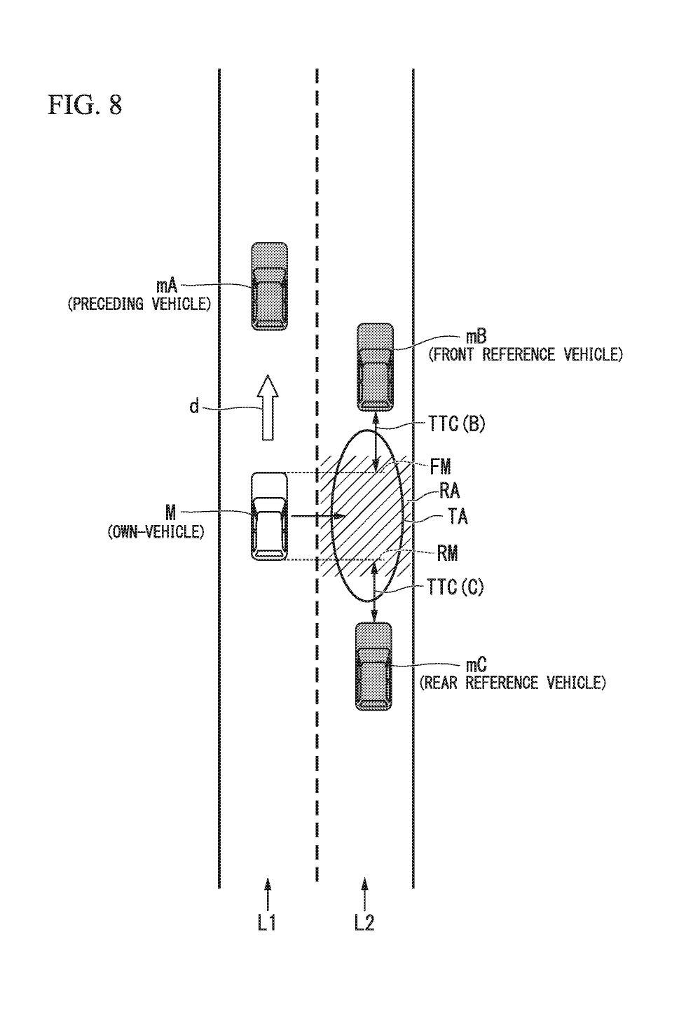

The lane change controller 158 operates when a lane change event, a branching event, a merging event, or the like are performed, that is, when a lane change in a broad sense is made. FIG. 7 is a flowchart showing an example of a flow of processing performed when a lane change event is performed. The processing will be described below with reference to FIG. 7 and FIG. 8.

First, the lane change controller 158 selects two nearby vehicles from those traveling in an adjacent lane to which lane change is to be made and that is adjacent to the lane (own-lane) in which the own-vehicle M travels and sets a target position TA between these nearby vehicles (step S100). Hereinafter, a nearby vehicle traveling immediately in front of the target position TA in the adjacent lane will be referred to as a front reference vehicle mB and a nearby vehicle traveling immediately behind the target position TA in the adjacent lane will be referred to as a rear reference vehicle mC. The target position TA is a relative position based on the positional relationships between the own-vehicle M and the front and rear reference vehicles mB and mC.

FIG. 8 is a diagram showing how the target position TA is set. In FIG. 8, mA indicates a preceding vehicle, mB indicates a front reference vehicle, and mC indicates a rear reference vehicle. An arrow d indicates the direction of advance (traveling) of the own-vehicle M, L1 indicates the own-lane, and L2 indicates the adjacent lane. In the example of FIG. 8, the lane change controller 158 sets the target position TA between the front reference vehicle mB and the rear reference vehicle mC in the adjacent lane L2.

Next, the lane change controller 158 determines whether or not a primary condition for determining whether or not lane change can be made to the target position TA (that is, between the front reference vehicle mB and the rear reference vehicle mC) is satisfied (step S102).

The primary condition is, for example, that no parts of the nearby vehicle be present in a prohibited region RA provided in the adjacent lane and TTCs between the own-vehicle M and the front and rear reference vehicles mC and mB be greater than a threshold value. It is to be noted that this determination condition is an example when the target position TA is set lateral to the own-vehicle M. If the primary condition is not satisfied, the lane change controller 158 returns the processing to step S100 and resets the target position TA. Here, the lane change controller 158 may wait until a target position TA satisfying the primary condition can be set or may change the target position TA and then speed control for moving lateral to the target position TA may be performed.

As shown in FIG. 8, for example, the lane change controller 158 projects the own-vehicle M onto the lane L2 to which lane change is to be made and sets a prohibited region RA having slight margin distances forward and backward. The prohibited region RA is set as a region extending from one end to the other in the lateral direction of the lane L2.

When there is no nearby vehicle in the prohibited area RA, the lane change controller 158 assumes, for example, an extension line FM and an extension line RM that virtually extend from the front and rear ends of the own-vehicle M to the lane L2 to which lane change is to be made. The lane change controller 158 calculates a time to collision TTC(B) between the extension line FM and the front reference vehicle mB and a rear reference vehicle TTC(C) between the extension line RM and the rear reference vehicle mC. The time to collision TTC(B) is a time derived by dividing the distance between the extension line FM and the front reference vehicle mB by the relative speed between the own-vehicle M and the front reference vehicle mB. The time to collision TTC(C) is a time derived by dividing the distance between the extension line RM and the rear reference vehicle mC by the relative speed between the own-vehicle M and the rear reference vehicle mC. The lane change controller 158 determines that the primary condition is satisfied when the time to collision TTC(B) is greater than a threshold value Th(B) and the time to collision TTC(C) is greater than a threshold value Th(C). The threshold values Th(B) and Th(C) may be the same or different.

When the primary condition is satisfied, the lane change controller 158 causes the candidate trajectory generator 154 to generate a candidate trajectory for lane change (step S104). FIG. 9 is a diagram showing how a trajectory for lane change is generated. For example, the candidate trajectory generator 154 assumes that the preceding vehicle mA, the front reference vehicle mB, and the rear reference vehicle mC travel in predetermined speed models and calculates a candidate trajectory such that the own-vehicle M is positioned between the front reference vehicle mB and the rear reference vehicle mC at a future time without interfering with the preceding vehicle mA on the basis of the speed models of these three vehicles and the speed of the own-vehicle M. For example, the candidate trajectory generator 154 sequentially connects the current position of the own-vehicle M, the position of the front reference vehicle mB at a future time or the center of the lane to which lane change is to be made, and the end point of the lane change smoothly using a polynomial curve such as a spline curve and arranges a predetermined number of trajectory points K at equal or unequal intervals on this curve. At this time, the candidate trajectory generator 154 generates a trajectory such that at least one of the trajectory points K is arranged within the target position TA.

Next, the evaluation/selection unit 156 determines whether or not a candidate trajectory satisfying a set condition can be generated (step S106). The set condition is, for example, that an evaluation value equal to or higher than a threshold value from the viewpoint of the plan-related property or safety described above has been obtained. When candidate trajectories satisfying the set condition can be generated, the evaluation/selection unit 156 selects, for example, a trajectory candidate with the highest evaluation value, outputs information of the trajectory to the travel controller 160, and causes the travel controller 160 to execute lane change (step S108). On the other hand, when a trajectory satisfying the set condition cannot be generated, the processing returns to step S100. Here, a process of entering a waiting state or resetting the target position TA may be performed like when the determination is negative in step S102.

The predictor 159 predicts lane change of nearby vehicles to the own-lane in which the own-vehicle M travels. The predictor 159 predicts lane change of nearby vehicles on the basis of the history of positions of the nearby vehicles, the operational states of direction indicators thereof, or the like. The predictor 159 predicts lane change of a nearby vehicle, for example, when the external environment recognizer 130 recognizes from an image captured by the camera 40 that a direction indicator of the nearby vehicle is operating, when it is notified through inter-vehicle communication that the nearby vehicle will change lanes, or when the nearby vehicle is approaching the traveling lane of the own-vehicle M in the lateral direction, or on the basis of a combination thereof.

The travel controller 160 controls the travel driving force output device 90, the steering device 92, and the brake device 94 such that the own-vehicle M passes along the trajectory generated by the trajectory generator 150 at scheduled times.

The switching controller 170 switches the driving mode on the basis of a driving mode designation signal input from the changeover switch 80 and also switches the driving mode on the basis of an operation performed on the operation device 70 for instructing acceleration, deceleration or steering. For example, the switching controller 170 switches the driving mode from the automated driving mode to the manual driving mode when the amount of operation input from the operation detection sensor(s) 72 is kept greater than a threshold value for a reference time or more. Further, the switching controller 170 switches the driving mode from the automated driving mode to the manual driving mode near the destination of the automated driving.

When the driving mode is switched from the manual driving mode to the automated driving mode, the switching controller 170 performs the switching on the basis of a driving mode designation signal input from the changeover switch 80. Control such as that for returning to the automated driving mode may also be performed when an operation performed on the operation device 70 for instructing acceleration, deceleration or steering is not detected for a predetermined time after the driving mode is switched from the automated driving mode to the manual driving mode.

[Processing when Passing Through Specific Region]

The candidate trajectory generator 154 acquires information indicating the position of a specific region from the high-precision map information 182. If the relative relationship between the own-vehicle M and a nearby vehicle with respect to the own-vehicle M satisfies a predetermined condition when the own-vehicle M passes through the specific region, the candidate trajectory generator 154 sets the speed of the own-vehicle M to less than the speed of the target vehicle.

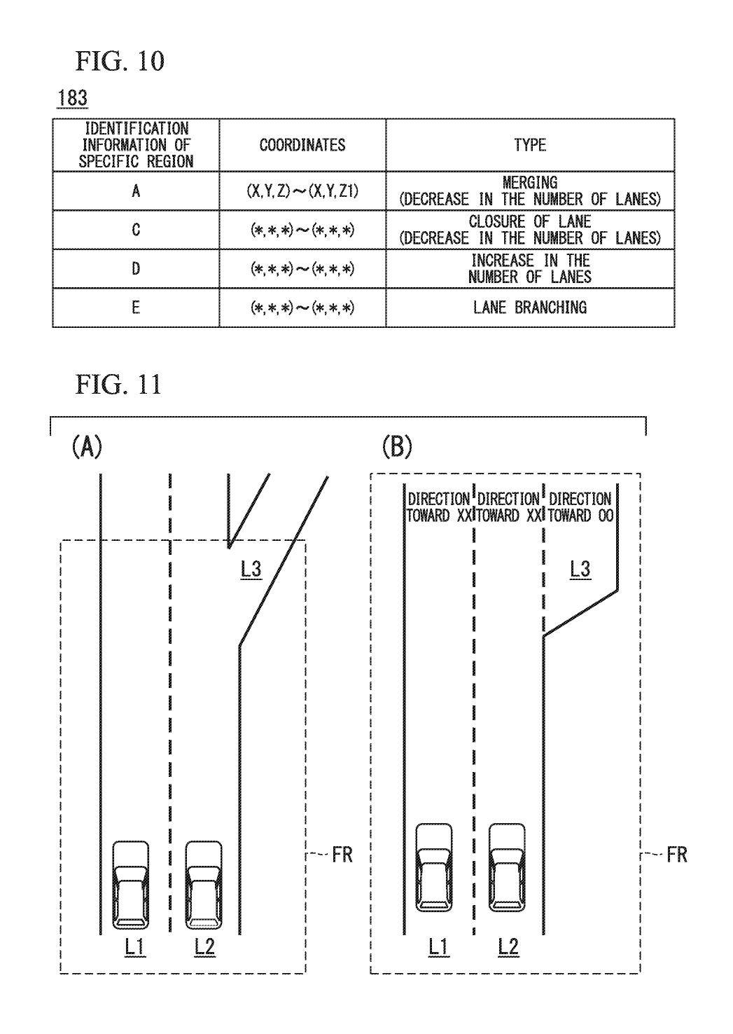

A specific region table 183 is stored in the high-precision map information 182. FIG. 10 is a diagram showing an example of the specific region table 183. In the specific region table 183, information indicating the positions of specific regions (for example, three-dimensional coordinates) and information indicating the types of the specific regions (such as lane merging or lane branching) are stored in association with identification information of the specific regions. The specific regions are regions in which vehicles frequently change lanes and examples thereof include a location where lanes merger, a location where a lane is closed, a location where the number of lanes increases, and a location where a lane branches.

The specific regions may also include a location where vehicles frequently change lanes, which is derived in advance through an experimental or statistical method. The specific regions may also include, for example, regions where a vehicle is likely to move to an overtaking lane, perform overtaking, and then return to its own-lane due to their topographical features such as a gradient.

In addition, the position information indicating the position of a specific region may be associated with information regarding a road stored in the high-precision map information 182. The information regarding a road is, for example, a reference point (a road node ID) on a road reference line along the road, a road link ID, or the like. The road link ID is information associated with a road node ID connected as a start point of the road link (a start point road node ID) and a road node ID connected as an end point of the road link (an end point road node ID).

FIG. 11(A) is a diagram showing an example of a road shape at a location where a lane branches. In the shown example, there are traveling lanes L1 and L2 and a branching lane L3 which branches from the traveling lane L2. When there is the branching lane L3, vehicles traveling in the traveling lane L1 frequently change lanes to the traveling lane L2 or L3 and therefore a region including at least a position immediately before this branching point can be set as a specific region FR.

FIG. 11(B) is a diagram showing an example of a road shape at a location where the number of lanes increases. In the shown example, there are traveling lanes L1 and L2 and a lane L3 is added in the middle of the traveling lane L2. For example, when the lane L3 added is a road heading in a direction different from the traveling lanes L1 and L2, vehicles traveling in the traveling lane L1 frequently change lanes to the traveling lane L2 or the added lane L3 and therefore a region including at least a position immediately before this point of increase in the number of lanes can be set as a specific region FR.

[Specific Processing when Passing Through Specific Region]

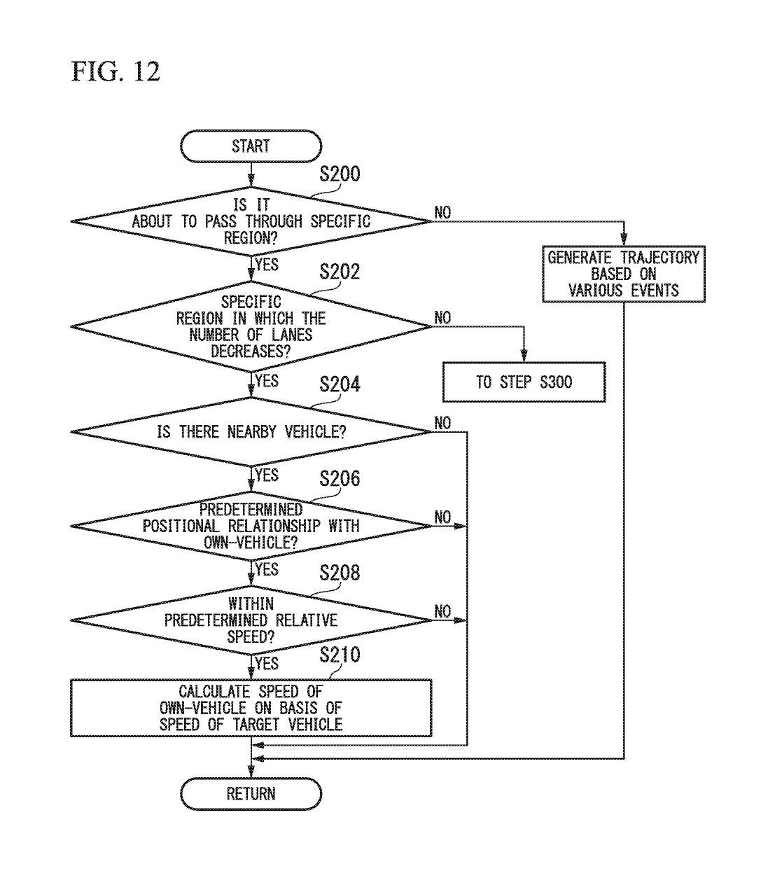

FIG. 12 is a diagram showing a part of a flowchart showing the flow of processing that the automated driving controller 120 performs when passing through a specific region FR. This processing will be described with reference to an example of processing when passing through a specific region FR where the number of lanes decreases.

First, the candidate trajectory generator 154 determines whether or not the own-vehicle M is about to pass through a specific region FR acquired from the high-precision map information 182 (step S200). The specific region FR acquired from the high-precision map information 182 is a region present on the route provided from the navigation device 50. The fact that the own-vehicle M is about to pass through the specific region FR means, for example, that the own-vehicle M has approached the specific region FR within a predetermined distance from the specific region FR or has entered the specific region FR. When the own-vehicle M is not about to pass through the specific region FR, the candidate trajectory generator 154 does not perform subsequent processing in this flowchart and generates a trajectory based on various events as described above.

When the own-vehicle M is about to pass through the specific region FR, the candidate trajectory generator 154 determines whether or not the specific region FR for passing through corresponds to a location where the number of lanes decreases on the basis of a type associated with the specific region FR (step S202). If the specific region FR does not correspond to a location where the number of lanes decreases, the processing proceeds to a process of step S300 (FIG. 15).

If the specific region FR corresponds to a location where the number of lanes decreases, the candidate trajectory generator 154 determines whether or not there is a nearby vehicle on the basis of the recognition result of the external environment recognizer 130 (step S204). When there is no nearby vehicle, the processing of this flowchart ends.

When there is a nearby vehicle, the candidate trajectory generator 154 determines whether or not the own-vehicle M and the nearby vehicle are in a predetermined positional relationship (step S206). The predetermined positional relationship is that the position of the nearby vehicle is within a predetermined region lateral to the own-vehicle M.

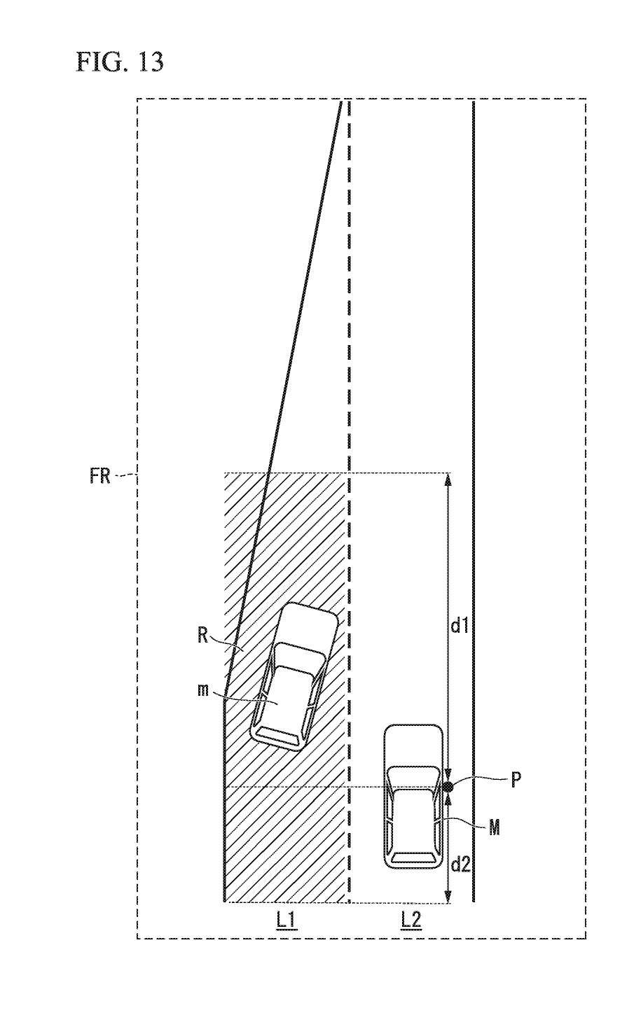

More specifically, the predetermined positional relationship is that all or a part of the nearby vehicle is within a predetermined region set lateral to the own-vehicle M. FIG. 13 is a diagram showing the positional relationship between the own-vehicle M and the nearby vehicle m. In FIG. 13, R indicates a predetermined region. The predetermined region R is a region extending to a first predetermined distance d1 forward from a reference point P of the own-vehicle M and to a second predetermined distance d2 rearward from a reference point P of the own-vehicle M in a merging lane L1 for merging into a traveling lane L2. For example, the reference point P is set at an arbitrary position such as the driver's seat of the own-vehicle M. In this manner, the predetermined region R may be set in a lane (L1 in FIG. 13) which is closed due to merging, that is, due to a decrease in the number of lanes. The first predetermined distance d1 is longer than the second predetermined distance d2. More specifically, d1 is set to about 20 meters and d2 is set to about 3 meters.

When the own-vehicle M and the nearby vehicle m are not in the predetermined positional relationship, the processing of this flowchart ends. When the own-vehicle M and the nearby vehicle m are in the predetermined positional relationship, the candidate trajectory generator 154 determines whether or not the relative speed of the nearby vehicle m with respect to the own-vehicle M is within a predetermined speed range (for example, plus or minus 10 km/h) (step S208). When the relative speed is not within the predetermined speed range, the processing of this flowchart ends.

For example, when the relative speed is not within the predetermined speed range, the own-vehicle M continues to travel at a speed which has been maintained so far, without considering the nearby vehicle m. This is because, for example, when the nearby vehicle m is sufficiently faster than the own-vehicle M (when the relative speed exceeds plus 10 km/h), the nearby vehicle m moves sufficiently ahead of the own-vehicle M in a short time, thus eliminating the positional relationship and, on the other hand, for example, when the nearby vehicle m is sufficiently slower than the own-vehicle M (when the relative speed is less than minus 10 km/h), the own-vehicle M moves sufficiently ahead of the nearby vehicle m in a short time, thus eliminating the positional relationship.

When the relative speed between the own-vehicle M and the nearby vehicle m is within the predetermined speed range, the candidate trajectory generator 154 calculates a target speed (Vego_car_target) of the own-vehicle M on the basis of the speed of the target vehicle (step S210). For example, the candidate trajectory generator 154 calculates the target speed, for example, using equation (1). In this equation, K is a preset value and is set to a value less than “1” (for example, about 0.8). Vtarget_car is the speed of the nearby vehicle m.

Vego_car_target=K*Vtarget_car (1)

The candidate trajectory generator 154 generates a candidate trajectory on the basis of the target speed calculated in step S210 and outputs the generated candidate trajectory to the evaluation/selection unit 156. As described above, the evaluation/selection unit 156 selects a trajectory candidate with the highest evaluation value, outputs information of the trajectory to the travel controller 160, and causes the own-vehicle M to decelerate. As a result, the processing of one routine of this flowchart ends.

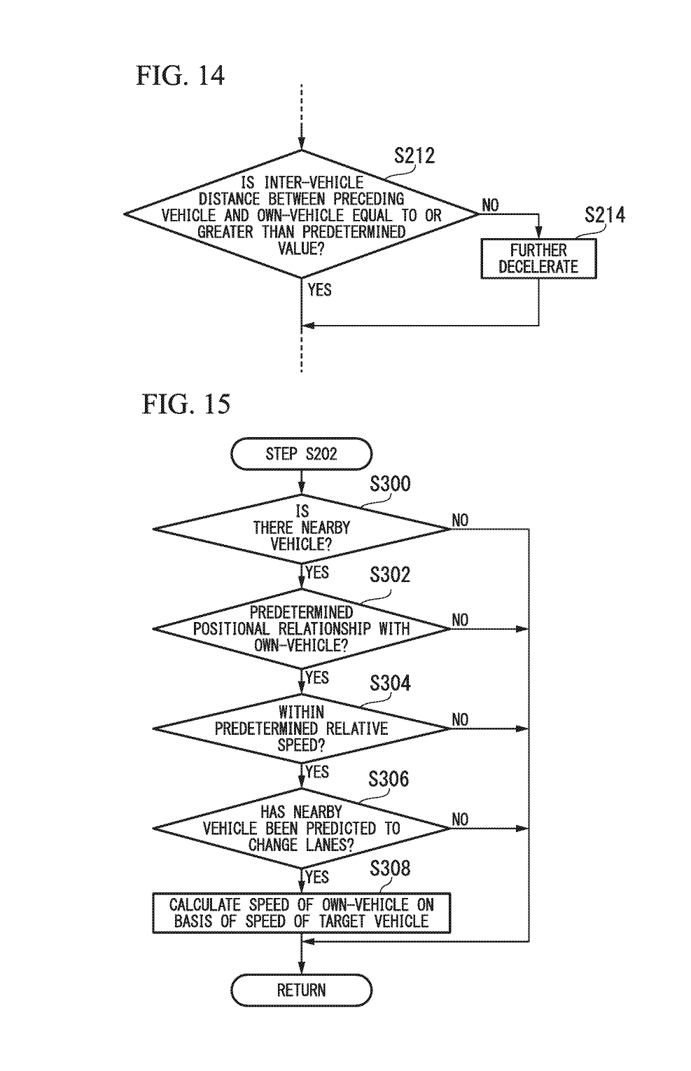

The above example has been described assuming that there is no preceding vehicle traveling in front of the own-vehicle M in the traveling lane L2. However, if there is a preceding vehicle, the candidate trajectory generator 154 may control the own-vehicle M taking into account the preceding vehicle. FIG. 14 is a diagram showing a flow of processing of a modified example of the flowchart of FIG. 12. This processing is performed after or instead of the process of step S210. The candidate trajectory generator 154 determines whether or not an inter-vehicle distance between the own-vehicle M and the preceding vehicle is equal to or greater than a predetermined value (step S212). When the inter-vehicle distance between the own-vehicle M and the preceding vehicle is equal to or greater than the predetermined value, the processing of one routine of this flowchart ends. When the inter-vehicle distance between the own-vehicle M and the preceding vehicle is not equal to or greater than the predetermined distance, the candidate trajectory generator 154 further decelerates the own-vehicle M such that the inter-vehicle distance between the own-vehicle M and the preceding vehicle is equal to or greater than the predetermined value (step S214). For example, even when the preceding vehicle decelerates while the own-vehicle M is following the preceding vehicle, the candidate trajectory generator 154 can control the own-vehicle M in accordance with deceleration of the preceding vehicle such that the inter-vehicle distance between the preceding vehicle and the own-vehicle M is kept equal to or greater than the predetermined value. Thereby, when the own-vehicle M enters a specific region FR such that the own-vehicle M and a nearby vehicle m (a side-traveling vehicle) are in a predetermined positional relationship, it is possible to prompt the nearby vehicle m to change lanes into the space between the own-vehicle M and the preceding vehicle.

Here, if it is assumed that the own-vehicle M is controlled without considering the nearby vehicle m traveling in the adjacent lane L1 in a situation where the own-vehicle M and the nearby vehicle m are traveling in a predetermined positional relationship as shown in FIG. 13, there is a possibility that the own-vehicle M will travel while keeping the same speed as previously or will accelerate regardless of presence of the nearby vehicle m scheduled to change lanes. In this case, it is difficult for the nearby vehicle m to change lanes, and aggressive automated driving for the nearby vehicle m is performed.

On the other hand, in the vehicle control system 100 according to the present embodiment, if the relative relationship between the own-vehicle M and the nearby vehicle m satisfies a predetermined condition when the own-vehicle M passes through a specific region FR, the speed of the own-vehicle M is set to a speed less than the speed of the target vehicle. Thereby, the vehicle control system 100 can realize gentle vehicle control for the nearby vehicle m.

FIG. 15 is a diagram showing another part of the flowchart showing the flow of processing that the automated driving controller 120 performs when passing through the specific region FR. The processing shown in FIG. 15 is performed when the candidate trajectory generator 154 determines in step S202 of FIG. 12 that the specific region FR is not one where the number of lanes decreases, that is, when the own-vehicle passes through a specific region FR corresponding to a location where the number of lanes increases or a lane branches or another location where vehicles frequently change lanes.

First, the candidate trajectory generator 154 determines whether or not there is a nearby vehicle m on the basis of the recognition result of the external environment recognizer 130 (step S300). When there is no nearby vehicle m, the processing of this flowchart ends.

When there is a nearby vehicle m, the candidate trajectory generator 154 determines whether or not the own-vehicle M and the nearby vehicle m are in a predetermined positional relationship (step S302). When the own-vehicle M and the nearby vehicle m are not in the predetermined positional relationship, the processing of this flowchart ends.

When the own-vehicle M and the nearby vehicle m are in the predetermined positional relationship, the candidate trajectory generator 154 determines whether or not the relative speed of the nearby vehicle m with respect to the own-vehicle M is within a predetermined speed range (step S304). When the relative speed is not within the predetermined speed range, the processing of this flowchart ends.

When the relative speed is within the predetermined speed range, the candidate trajectory generator 154 determines whether or not the predictor 159 has predicted that the nearby vehicle m will change lanes (step S306).

When the nearby vehicle m has not been predicted to change lanes, the processing of one routine of the flowchart ends. When the nearby vehicle m has been predicted to change lanes, the candidate trajectory generator 154 calculates a target speed of the own-vehicle M on the basis of the speed of the target vehicle (step S308). The candidate trajectory generator 154 calculates the target speed on the basis of the above equation (1). The candidate trajectory generator 154 generates a candidate trajectory on the basis of the target speed calculated in step S308 and outputs the generated candidate trajectory to the evaluation/selection unit 156. As a result, the processing of the routine of this flowchart ends. Here, it is to be noted that the processes of step S212 and step S214 in the flowchart of FIG. 14 may be performed after or instead of the process of step S308.

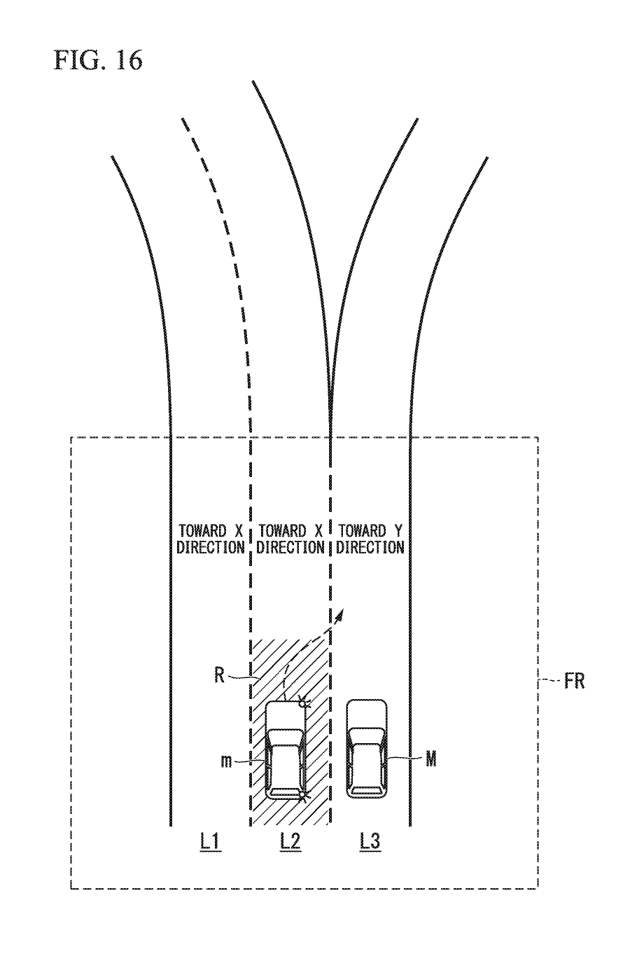

FIG. 16 is a diagram showing an example of a situation in which a nearby vehicle m has been predicted to change lanes. In the shown example, a traveling lane L1, a traveling lane L2 in which the nearby vehicle m is traveling, and a traveling lane L3 in which the own-vehicle M is traveling branch into two directions, an X direction and a Y direction. When there is a nearby vehicle m in a specific region FR at such a branching location, the nearby vehicle m may sometimes continue to travel in the traveling lane L2 and advance in the X direction or may sometimes change lanes to the traveling lane L3 and advance in the Y direction. In the example of FIG. 16, the nearby vehicle m is about to change lanes to the traveling lane L3.

For example, if it is assumed that the own-vehicle M is controlled without considering the nearby vehicle m traveling in the adjacent lane L2 in a situation where the own-vehicle M and the nearby vehicle m are traveling in a predetermined positional relationship within a specific region RF at a branching location, there is a possibility that the own-vehicle M will travel while keeping the same speed as previously or will accelerate regardless of presence of the nearby vehicle m that may change lanes. In this case, it is difficult for the nearby vehicle m to change lanes even if the nearby vehicle m intends to change lanes.

On the other hand, in the present embodiment, when the nearby vehicle m passes through a specific region FR at a branching location where the nearby vehicle m is highly likely to change lanes, the automated driving control system 100 sets the speed of the own-vehicle M to a speed less than the speed of the target vehicle if the predictor 159 has predicted that the target vehicle will change lanes. As a result, it is possible to realize gentle automated driving for the nearby vehicle m.

It is to be noted that the candidate trajectory generator 154 may also perform the above processing when the own-vehicle M passes through the specific region FR at a predetermined speed or higher. When the speed of the own-vehicle M is less than the predetermined speed (within a medium speed range) due to congestion or the like, the candidate trajectory generator 154 may calculate the speed of the own-vehicle M without performing the above processing.

Further, the candidate trajectory generator 154 may refer to the prediction result of the predictor 159 also in the processing of the flowchart of FIG. 12. This allows the candidate trajectory generator 154 to realize gentle automated driving for a nearby vehicle m with higher precision even in a specific region FR where the number of lanes decreases.

In addition, the candidate trajectory generator 154 may perform deceleration control only for a specific region FR where the number of lanes decreases or may perform deceleration control only when lane change is predicted in a specific region FR where the number of lanes increases or a lane branches.

According to the first embodiment described above, if the relative relationship between the nearby vehicle m and the own-vehicle M satisfies a predetermined condition when the own-vehicle M passes through a specific region FR where the number of lanes decreases, the vehicle control system 100 sets the speed of the own-vehicle M to a speed less than the speed of the target vehicle. Further, if the relative relationship between the nearby vehicle m and the own-vehicle M satisfies a predetermined condition and the target vehicle has been predicted to change lanes when the own-vehicle M passes through a specific region FR where the number of lanes increases or a lane separates, the vehicle control system 100 sets the speed of the own-vehicle M to a speed less than the speed of the target vehicle. As a result, the vehicle control system 100 can realize gentle vehicle control for the nearby vehicle m.

### Second Embodiment

A second embodiment will be described below. The vehicle control system 100A in the second embodiment differs from that of the first embodiment in that it is applied to an apparatus that does not set events on the basis of a route to the destination to perform automated driving but simply performs a travel following a preceding vehicle which is traveling in front of the own-vehicle M. Hereinafter, such differences will be mainly described and constituent elements having the same functions as those of the first embodiment are denoted by the same reference signs and the description thereof will be omitted as appropriate.

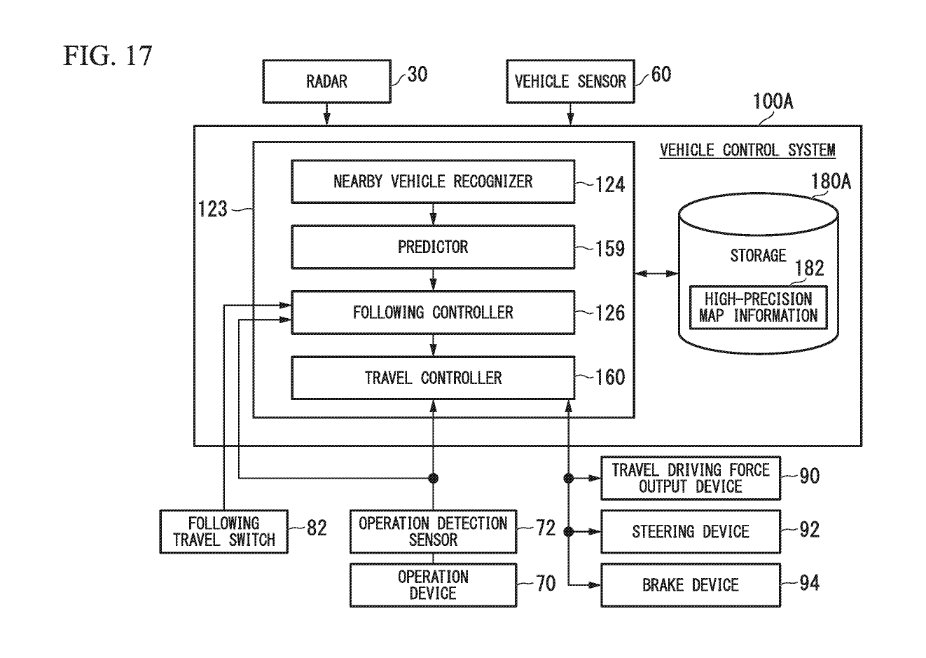

FIG. 17 is a functional configuration diagram of the own-vehicle M centering on the vehicle control system 100A according to the second embodiment. The vehicle control system 100A including radars 30, vehicle sensors 60, an operation device 70, an operation detection sensor 72, a following travel switch 82, a travel driving force output device 90, a steering device 92, and a brake device 94 is mounted in the own-vehicle M.

The vehicle control system 100A includes, for example, a driving assistor 123 and a storage 180A. The driving assistor 123 includes a nearby vehicle recognizer 124, a following controller 126, a predictor 159, and a travel controller 160. The storage 180A stores high-precision map information 182.

The following travel switch 82 is a switch that is operated by the driver or the like. The following travel switch 82 receives an operation of the driver or the like, generates a control mode designation signal for designating a control mode of the travel controller 160 as one of a following travel mode or a manual driving mode, and outputs the control mode designation signal to the following controller 126. The following travel mode is a mode in which, when there is a preceding vehicle, the own-vehicle travels following the preceding vehicle while keeping a constant inter-vehicle distance from the preceding vehicle and, when there is no preceding vehicle, the own-vehicle travels at a preset speed.

The nearby vehicle recognizer 124 recognizes vehicles near the own-vehicle M (nearby vehicles) detected by the radars 30. The following controller 126 calculates a target speed of the own-vehicle M upon receiving an operation of the driver or the like through the following travel switch 82. When there is no preceding vehicle, the following controller 126 calculates a preset target speed. When there is a preceding vehicle, the following controller 126 calculates a target speed such that the own-vehicle M travels following the preceding vehicle while keeping the inter-vehicle distance between the preceding vehicle and the own-vehicle M constant.

The following controller 126 acquires information indicating the position of a specific regions FR from the high-precision map information 182. If the relative relationship between the own-vehicle M and the nearby vehicle m detected by the nearby vehicle recognizer 124 satisfies a predetermined condition when the own-vehicle M passes through the acquired specific region FR, the following controller 126 sets the speed of the own-vehicle M to a speed less than the speed of the target vehicle on the basis of the speed of the target vehicle.

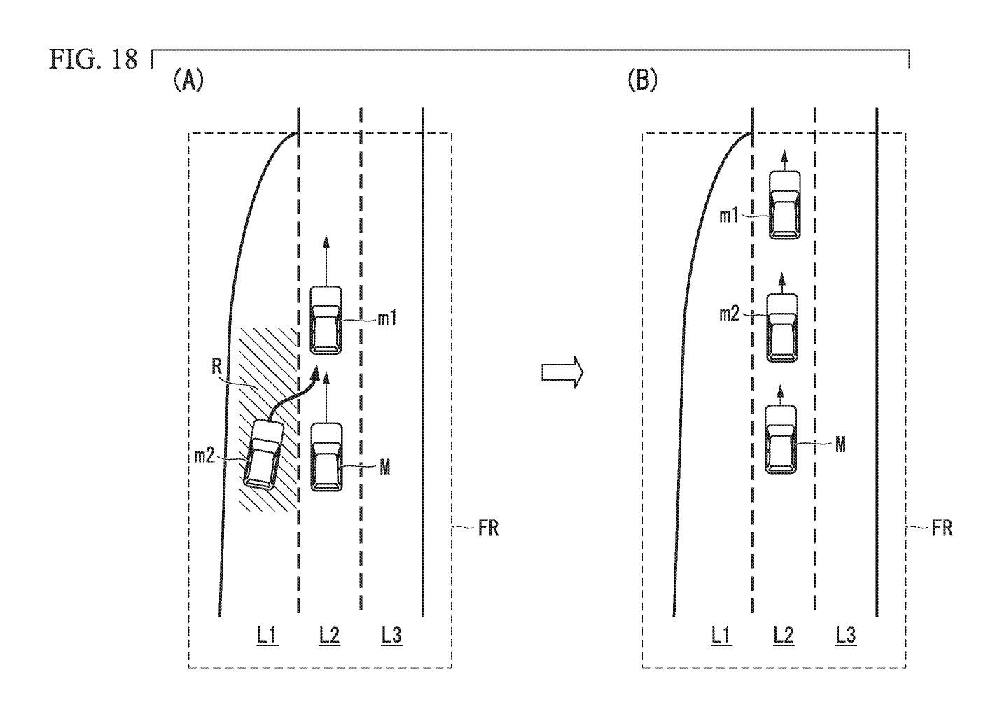

The following controller 126 realizes the deceleration control described above by performing the same processing as that described with reference to the flowchart of FIG. 12 or the flowchart of FIG. 15 of the first embodiment described above. FIG. 18 is a diagram showing an example of a situation in which the following controller 126 performs setting for the own-vehicle M on the basis of the speed of the target vehicle. In the shown example, there are traveling lanes L2 and L3 and there is a merging lane L1 for merging into the traveling lane L2. It is assumed that the own-vehicle M travels following a nearby vehicle m1 and a nearby vehicle m2 is about to change lanes from the merging lane L3 to the traffic lane L2.

As shown in FIG. 18(A), if the relative relationship between the nearby vehicle m2 and the own-vehicle M satisfies a predetermined condition when the own-vehicle M passes through the specific region FR at the merging location, the automated driving control system 100 does not cause the own-vehicle to travel following the nearby vehicle m1 such that the own-vehicle keeps the same speed as previously or accelerates, but instead sets the speed of the own-vehicle M to a speed less than the speed of the target vehicle. Thereby, the automated driving control system 100 can cause the target vehicle which is merging into the traveling lane L2 from the merging lane L1 to change lanes to the front of the own-vehicle M as shown in FIG. 18(B). As a result, the vehicle control system 100A can realize gentle vehicle control for nearby vehicles m.

The travel controller 160 acquires the target speed calculated by the following controller 126 and controls the amount of operation of the accelerator pedal, the brake device 94, or the travel driving force output device 90 such that the own-vehicle M travels at the acquired target speed. The following controller 126 also switches the control mode of the own-vehicle M of the travel controller 160 from the following control mode to the manual driving mode on the basis of an operation detection signal input from the operation detection sensor 72.

According to the second embodiment described above, if the relative relationship between a nearby vehicle m and the own-vehicle M satisfies a predetermined condition when the own-vehicle M is traveling in the following travel mode, the vehicle control system 100A sets the speed of the own-vehicle M to a speed less than the speed of the target vehicle, whereby it is possible to realize gentle vehicle control for the nearby vehicle m.

Although the mode for carrying out the present invention has been described above by way of embodiments, the present invention is not limited to these embodiments at all and various modifications and substitutions may be made without departing from the spirit of the present invention.

### REFERENCE SIGNS LIST

20 Finder
30 Radar
40 Camera
50 Navigation device
60 Vehicle sensor
62 Display unit
64 Speaker
70 Operation device
72 Operation detection sensor
80 Changeover switch
90 Travel driving force output device
92 Steering device
94 Brake device
100 Vehicle control system
110 Target lane determinator
120 Automated driving controller
122 Own-vehicle position recognizer
123 Driving assistor
124 Nearby vehicle recognizer
126 Following controller
130 External environment recognizer
140 Behavior plan generator
150 Trajectory generator
154 Candidate trajectory generator
159 Predictor
160 Travel controller
170 Switching controller
180 Storage
182 High-precision map information
183 Specific region table
M Own-vehicle

What is claim is:

1.-12. (canceled)

13. A vehicle control system comprising:
a vehicle detector configured to detect a nearby vehicle with respect to an own-vehicle;
a predictor configured to predict lane change of the nearby vehicle to an own-lane in which the own-vehicle travels; and
an automated driving controller configured to automatically control at least acceleration/deceleration of the own-vehicle such that the own-vehicle can travel along a route to a destination,
wherein the automated driving controller is configured to acquire information indicating a position of at least one of a first specific region in which the number of lanes decreases or a second specific region in which the number of lanes increases or a lane branches from map information and to perform at least one of a first process for the first specific region or a second process for the second specific region,
the first process includes setting a speed of the own-vehicle to less than a speed of a nearby vehicle detected by the vehicle detector if a relative relationship between the own-vehicle and the nearby vehicle detected by the vehicle detector satisfies a predetermined condition when the own-vehicle passes through the first specific region,
the second process includes setting the speed of the own-vehicle to less than a speed of a nearby vehicle detected by the vehicle detector if a relative relationship between the own-vehicle and the nearby vehicle detected by the vehicle detector satisfies a predetermined condition and the predictor has predicted that the nearby vehicle will change lanes to the own-lane when the own-vehicle passes through the second specific region, and
the predetermined condition is at least that a position of the nearby vehicle be within a predetermined region lateral to the own-vehicle, wherein the predetermined region includes an entire longitudinal length of the own-vehicle and a front part of the predetermined region with respect to the own-vehicle is larger than a rear part of the predetermined region with respect to the own-vehicle.

14. The vehicle control system according to claim 13, wherein the predetermined region is set in a lane that is closed as the number of lanes decreases.

15. A vehicle control system comprising:
a vehicle detector configured to detect a nearby vehicle with respect to an own-vehicle;
a predictor configured to predict lane change of the nearby vehicle to an own-lane in which the own-vehicle travels; and
an automated driving controller configured to automatically control at least acceleration/deceleration of the own-vehicle such that the own-vehicle can travel along a route to a destination,
wherein the automated driving controller is configured to acquire information indicating a position of at least one of a first specific region in which the number of lanes decreases or a second specific region in which the number of lanes increases or a lane branches from map information and to perform at least one of a first process for the first specific region or a second process for the second specific region,
the first process includes setting a speed of the own-vehicle to less than a speed of a nearby vehicle detected by the vehicle detector if a relative relationship between the own-vehicle and the nearby vehicle detected by the vehicle detector satisfies a predetermined condition when the own-vehicle passes through the first specific region,
the second process includes setting the speed of the own-vehicle to less than a speed of a nearby vehicle detected by the vehicle detector if a relative relationship between the own-vehicle and the nearby vehicle detected by the vehicle detector satisfies a predetermined condition and the predictor has predicted that the nearby vehicle will change lanes to the own-lane when the own-vehicle passes through the second specific region, and
the predetermined condition is at least that a relative speed between the nearby vehicle and the own-vehicle be within a predetermined speed range.

16. The vehicle control system according to claim 13 or 15, wherein the automated driving controller is configured to set the speed of the own-vehicle to less than a speed of a nearby vehicle detected by the vehicle detector if a relative relationship between the own-vehicle and the nearby vehicle detected by the vehicle detector satisfies a predetermined condition and the predictor has predicted that the nearby vehicle will change lanes to the own-lane when the own-vehicle passes through the first specific region.

17. The vehicle control system according to any one of claims 13 to 15, wherein the automated driving controller is configured to perform control for setting the speed of the own-vehicle to a speed less than the speed of the nearby vehicle when the speed of the own-vehicle is equal to or higher than a predetermined speed.

18. A vehicle control system comprising:
a vehicle detector configured to detect a nearby vehicle with respect to an own-vehicle; and
an automated driving controller configured to automatically control at least acceleration/deceleration of the own-vehicle such that the own-vehicle can travel along a route to a destination,
wherein the automated driving controller is configured to acquire information indicating a position of a specific region in which the number of lanes decreases from map information and to adjust a speed of the own-vehicle such that an inter-vehicle distance between the own-vehicle and a preceding vehicle that travels immediately in front of the own-vehicle among nearby vehicles detected by the vehicle detector is equal to or greater than a predetermined distance if a relative relationship between the own-vehicle and a side-traveling vehicle that travels in a lane adjacent to a lane in which the own-vehicle travels among the nearby vehicles detected by the vehicle detector satisfies a predetermined condition when the own-vehicle passes through the acquired specific region, and
the predetermined condition is at least that a position of the nearby vehicle be within a predetermined region lateral to the own-vehicle, wherein the predetermined region includes an entire longitudinal length of the own-vehicle and a front part of the predetermined region with respect to the own-vehicle is larger than a rear part of the predetermined region with respect to the own-vehicle.

19. A vehicle control system comprising:
a vehicle detector configured to detect a nearby vehicle with respect to an own-vehicle; and
an automated driving controller configured to automatically control at least acceleration/deceleration of the own-vehicle such that the own-vehicle can travel along a route to a destination,
wherein the automated driving controller is configured to acquire information indicating a position of a specific region in which the number of lanes decreases from map information and to adjust a speed of the own-vehicle such that an inter-vehicle distance between the own-vehicle and a preceding vehicle that travels immediately in front of the own-vehicle among nearby vehicles detected by the vehicle detector is equal to or greater than a predetermined distance if a relative relationship between the own-vehicle and a side-traveling vehicle that travels in a lane adjacent to a lane in which the own-vehicle travels among the nearby vehicles detected by the vehicle detector satisfies a predetermined condition when the own-vehicle passes through the acquired specific region, and
the predetermined condition is at least that a relative speed between the nearby vehicle and the own-vehicle be within a predetermined speed range.

20. A vehicle control method comprising:
an in-vehicle computer detecting a nearby vehicle with respect to an own-vehicle;
predicting lane change of the nearby vehicle to an own-lane in which the own-vehicle travels;
automatically controlling at least acceleration/deceleration of the own-vehicle such that the own-vehicle can travel along a route to a destination; and
acquiring information indicating a position of at least one of a first specific region in which the number of lanes decreases or a second specific region in which the number of lanes increases or a lane branches from map information and performing at least one of a first process for the first specific region or a second process for the second specific region,
wherein the first process is a process of setting a speed of the own-vehicle to less than a speed of the detected nearby vehicle if a relative relationship between the own-vehicle and the detected nearby vehicle satisfies a predetermined condition when the own-vehicle passes through the first specific region,
the second process is a process of setting the speed of the own-vehicle to less than a speed of the detected nearby vehicle if a relative relationship between the own-vehicle and the detected nearby vehicle satisfies a predetermined condition and the predictor has predicted that the nearby vehicle will change lanes to the own-lane when the own-vehicle passes through the second specific region, and
the predetermined condition is at least that a position of the nearby vehicle be within a predetermined region lateral to the own-vehicle, wherein the predetermined region includes an entire longitudinal length of the own-vehicle and a front part of the predetermined region with respect to the own-vehicle is larger than a rear part of the predetermined region with respect to the own-vehicle.

21. A non-transitory computer-readable storage medium that stores a vehicle control computer program to be executed by a computer to perform at least:
detect a nearby vehicle with respect to an own-vehicle;
predict lane change of the nearby vehicle to an own-lane in which the own-vehicle travels;
automatically control at least acceleration/deceleration of the own-vehicle such that the own-vehicle can travel along a route to a destination; and
acquire information indicating a position of at least one of a first specific region in which the number of lanes decreases or a second specific region in which the number of lanes increases or a lane branches from map information and perform at least one of a first process for the first specific region or a second process for the second specific region,
wherein the first process is a process of setting a speed of the own-vehicle to less than a speed of the detected nearby vehicle if a relative relationship between the own-vehicle and the detected nearby vehicle satisfies a predetermined condition when the own-vehicle passes through the first specific region,
the second process is a process of setting the speed of the own-vehicle to less than the speed of the detected nearby vehicle if a relative relationship between the own-vehicle and the detected nearby vehicle satisfies a predetermined condition and the predictor has predicted that the nearby vehicle will change lanes to the own-lane when the own-vehicle passes through the second specific region, and
the predetermined condition is at least that a position of the nearby vehicle be within a predetermined region lateral to the own-vehicle, wherein the predetermined region includes an entire longitudinal length of the own-vehicle and a front part of the predetermined region with respect to the own-vehicle is larger than a rear part of the predetermined region with respect to the own-vehicle.
